(19) United States
(12) Patent Application Publication
(10) Pub. No.: US 2009/0086240 A1
(43) Pub. Date: Apr. 2, 2009

(54) Method of controlling an unmanned automatic terminal for printing images and unmanned automatic terminal applying the method

(75) Inventor: Won-jung Kim, Seongnam-si (KR)

Correspondence Address: DRINKER BIDDLE & REATH LLP;ATTN: PATENT DOCKET DEPT., 191 N. WACKER DRIVE, SUITE 3700, CHICAGO, IL, 60606, US

(73) Assignee: Samsung Techwin Co., Ltd., Changwon-city (KR)

(21) Appl. No.: 12/152,690

(22) Filed: May 15, 2008

(30) Foreign Application Priority Data
Sep. 28, 2007 (KR) 10-2007-0098377

(51) Int. Cl. G06F 3/12

(52) U.S. Cl. 358/1.13

(57) ABSTRACT

Provided are methods of controlling an unmanned automatic terminal for printing images and unmanned automatic terminals applying the methods. Various embodiments of the method include performing a print mode operation in which images are printed and deposited into a depository and later performing a pick-up mode operation in which the printed images are released under a predetermined condition. According to embodiments of the present invention, the user may pick up the printed images at a desired time without waiting around for the terminal to finish printing the images.

### CROSS-REFERENCE TO RELATED PATENT APPLICATION

This application claims the benefit of Korean Patent Application No. 10-2007-0098377, filed on Sep. 28, 2007, in the Korean Intellectual Property Office, the disclosure of which is incorporated herein in its entirety by reference.

### BACKGROUND OF THE INVENTION

1. Field of the Invention

The present invention relates to a method of controlling an unmanned automatic terminal for printing images and an unmanned automatic terminal applying the method.

2. Description of the Related Art

Recently, various services are being performed by using unmanned automation systems. In order to operate the unmanned automation systems, unmanned automatic terminals are required. These unmanned automatic terminals also may be referred to as kiosks.

A representative example of a kiosk is an automated teller machine (ATM). A kiosk also may be used for printing images. Kiosks for printing images may provide an advantage in that users may easily print images anytime and anywhere.

A conventional unmanned automatic terminal for printing images is operated by using a system in which a user inputs an image file, an image corresponding to the image file is printed, and the printed image may be picked up by the user right after the images are printed. Because the unmanned automatic terminal is an unmanned system, to pick up the printed image the user has to wait around near the unmanned automatic terminal until the image is completely printed. If the user inputs a large number of image files, a long period of time is required to print corresponding images. As a result, the user cannot leave the unmanned automatic terminal for a long period of time.

### SUMMARY OF THE INVENTION

Various embodiments of the present invention provide methods of controlling an unmanned automatic terminal for printing images and unmanned automatic terminals applying the methods.

According to an aspect of the present invention, there is provided a method of controlling an unmanned automatic terminal for printing images, the method including performing a print mode operation in which images corresponding to one or more image files are printed so as to generate printed images and the printed images are deposited; and performing a pick-up mode operation in which the deposited images are released under predetermined conditions so that a user may pick up the printed images.

An example of a predetermined condition under which deposited images may be released is when order information input in the pick-up mode operation is identical to order information set in the print mode operation. In addition, another example of a predetermined condition under which deposited images may be released is when a user password input in the pick-up mode operation is identical to a user password set in the print mode operation.

According to another aspect of the present invention, there is provided a method of controlling an unmanned automatic terminal for printing images, the method including selecting either a print mode operation in which images corresponding to one or more image files input from an external storage device are printed so as to generate printed images or a pick-up mode operation in which the printed images are released so as to be picked up by a user; setting order information corresponding to the selection of the print mode operation in the print mode operation; printing the images corresponding to the image files so as to generate the printed images in the print mode operation; depositing the printed images in the print mode operation; inputting the order information in the pick-up mode operation; determining whether the order information input in the pick-up mode operation is identical to the order information set in the print mode operation; and releasing the printed images if the order information input in the pick-up mode operation is identical to the order information set in the print mode operation.

The method may further include setting user passwords corresponding to the selection of the print mode operation in the print mode operation; inputting the user passwords in the pick-up mode operation; determining whether the user passwords input in the pick-up mode operation are identical to the user passwords set in the print mode operation; and releasing the printed images if the order information input in the pick-up mode operation is identical to the order information set in the print mode operation and if the user passwords input in the pick-up mode operation are identical to the user passwords set in the print mode operation.

The method may further include storing the order information and/or the user passwords set in the print mode operation in the external storage device; and inputting the order information and/or the user passwords from the external storage device to the unmanned automatic terminal in the pick-up mode operation.

The method may further include setting a pick-up time of the printed images in the print mode operation. Here, the pick-up time may be a point of time when the user wants to pick up the printed images. The pick-up time may be directly set by the user or be automatically set by the unmanned automatic terminal.

The method may further include calculating a period of time that is necessary to generate the printed images in the print mode operation. Thus, by setting the pick-up time to be later than the calculated period of time, the user may pick up the printed images without waiting around while the images are being printed. Also, by notifying the user regarding the calculated period of time, the user may set the pick-up time to be later than the calculated period of time. Alternatively, the unmanned automatic terminal may automatically set the pick-up time based on the calculated period of time. The period of time may be calculated in consideration of the number or size of image files.

According to another aspect of the present invention, there is provided an unmanned automatic terminal for printing images, the unmanned automatic terminal including an input unit for selecting a print mode operation in which images corresponding to one or more image files input from an external storage device are printed or a pick-up mode operation in which the printed images are released so as to be picked up by a user; a print unit for printing the images corresponding to the image files so as to generate printed images; a depository for depositing the printed images; a control unit comprising an order information setting unit for setting order information corresponding to the selection of the print mode operation in the print mode operation and a first authentication unit for determining whether the order information input in the pick-up mode operation is identical to the order information set in the print mode operation; and a releasing unit for releasing the printed images if it is determined that the order information input in the pick-up mode operation is identical to the order information set in the print mode operation.

The control unit may further include a user password setting unit for setting user passwords corresponding to the selection of the print mode operation in the print mode operation, and a second authentication unit for determining whether the user passwords input in the pick-up mode operation are identical to the user passwords set in the print mode.

The order information and the user passwords may be input through the input unit in the pick-up mode operation.

The order information and/or the user passwords may be stored in the external storage device in the print mode operation and the order information and/or the user passwords may be input from the external storage device in the pick-up mode operation.

The control unit may further include a calculation unit for calculating a period of time is necessary to generate the printed images in the print mode operation.

The depository may be composed of a plurality of sub-depositories and corresponding printed images may be stored in each of the sub-depositories in accordance with the order information.

The releasing unit may release the printed images deposited in the depository in accordance with a control signal of the first authentication unit of the control unit. That is, if a first authentication unit authenticates that the order information of the print mode operation is identical to the order information of the pick-up mode operation, a first control signal may be transmitted to the releasing unit and the releasing unit may release the printed images deposited in the depository, in accordance with the order information. If the user passwords are also set, the releasing unit may release the printed image in accordance with the order information based on a second control signal indicating that the user passwords of the print mode operation are identical to the user passwords of the pick-up mode operation.

### BRIEF DESCRIPTION OF THE DRAWINGS

The above and other features and advantages of the present invention will become more apparent by describing in detail exemplary embodiments thereof with reference to the attached drawings in which:

FIG. 1 is a diagram illustrating a network system of a kiosk, according to an embodiment of the present invention;

FIG. 2 is a block diagram illustrating an internal configuration of the kiosk illustrated in FIG. 1, according to an embodiment of the present invention;

FIG. 3 is a block diagram of the control unit illustrated in FIG. 2, according to another embodiment of the present invention;

FIG. 4 is a block diagram of the control unit illustrated in FIG. 2, according to another embodiment of the present invention;

FIG. 5 is a block diagram of the control unit illustrated in FIG. 2, according to another embodiment of the present invention;

FIG. 6 is a flowchart illustrating a print mode operation of a kiosk, according to an embodiment of the present invention;

FIG. 7 is a flowchart of a method of processing order information and user passwords in a print mode operation of a kiosk, according to an embodiment of the present invention;

FIG. 8 is a flowchart for describing a pick-up mode operation of a kiosk, according to an embodiment of the present invention; and

FIG. 9 is a flowchart of a method of inputting order information and/or user passwords in a pick-up mode operation of a kiosk, according to an embodiment of the present invention.

### DETAILED DESCRIPTION OF THE INVENTION

The present invention will now be described more fully with reference to the accompanying drawings, in which exemplary embodiments of the invention are shown. Like reference numerals denote like elements in the drawings.

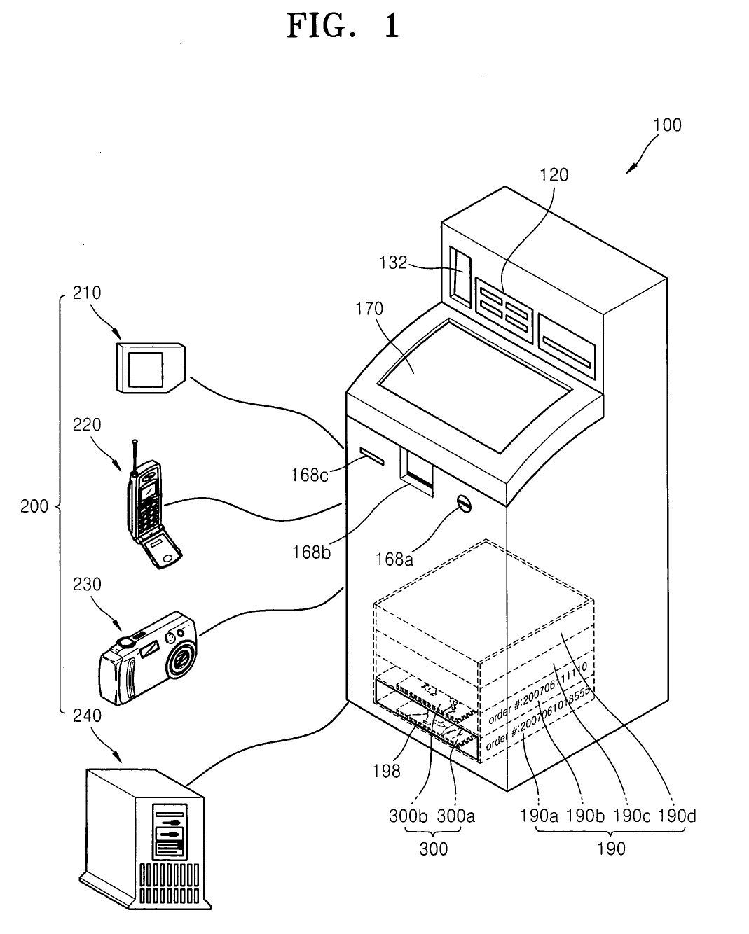

FIG. 1 is a diagram for describing a network system of a kiosk 100, according to an embodiment of the present invention.

Referring to FIG. 1, a kiosk 100 according to an embodiment of the present invention performs a print mode operation and a pick up mode operation. In the print mode operation, images are printed and the printed images 300 are deposited. In the pick-up mode operation, the images deposited during the print mode operation are released to a user.

In order to perform the print mode operation, the kiosk 100 may be connected to the external storage device 200 and receive one or more image files from the external storage device 200. The external storage device 200 may be any device or medium suitable for storing image files, such as a memory card 210, a cellular phone 220, a digital camera 230, or an information providing server 240. Also, the kiosk 100 may store data that corresponds to a user's selection of the print mode operation, e.g., order information and/or user passwords, in the external storage device 200, and the kiosk 100 may retrieve the data which are stored in the external storage device 200 from the external storage device 200 in order to perform the pick-up mode operation.

The kiosk 100 may include an input unit 120 comprising, for example, buttons, a card reader unit 132 for reading the memory card 210, a first money slot 168a for inserting coins, a second money slot 168b for inserting bills, a third money slot 168c for inserting a credit card, a display unit 170, and a releaser 198 for releasing printed images 300. The display unit 170 may be, for example, a liquid crystal display (LCD) device or an organic light-emitting diode (OLED).

The kiosk 100 may include a depository 190 and a releasing unit (not shown) for providing the printed images 300 through the releaser 198. The releasing unit and the depository 190 will be described in more detail later.

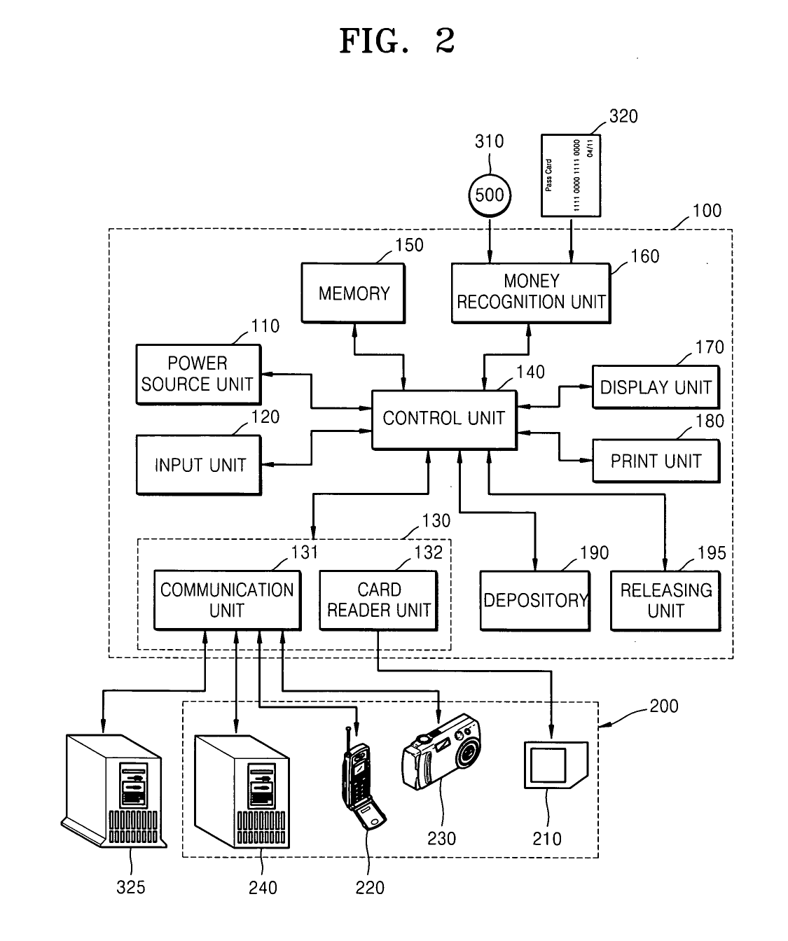

Example internal configurations of the kiosk 100 will now be described. FIG. 2 is a block diagram illustrating an internal configuration of the kiosk 100 illustrated in FIG. 1, according to an embodiment of the present invention. FIG. 2 will be described in conjunction with FIG. 1.

Referring to FIG. 2 and the embodiment of the present invention illustrated therein, the kiosk 100 performs a print mode operation and a pick-up mode operation by receiving electric power supplied from a power source unit 110. The print mode operation and the pick-up mode operation may be selected by the input unit 120. The input unit 120 may comprise, for example, a keyboard including a plurality of manipulation keys, a mouse for moving a pointer on a display screen and for selecting functions, and a touch screen for directly inputting instructions on the display screen.

An interface unit 130 is connected to the external storage device 200 in which image files and other data such as order information and/or user passwords are stored. The image files and other data may be provided by the interface unit 130. In more detail, the interface unit 130 may include the card reader unit 132 for receiving the image files and the other data from the memory card 210 and a communication unit 131 for providing wired/wireless connection with the cellular phone 220, the digital camera 230, or the information providing server 240. Also, the interface unit 130 may further include a terminal unit (not shown) connected to a flash memory and/or a driver (not shown) for reading image files stored in a floppy disk (FD), a compact disk (CD), or a digital versatile disc (DVD).

A control unit 140 controls each component of the kiosk 100 in order to perform the print mode operation and the pick-up mode operation. Also, the control unit 140 according to the present invention sets the order information that corresponds to a selection of the print mode operation and performs authentication in the pick-up mode operation.

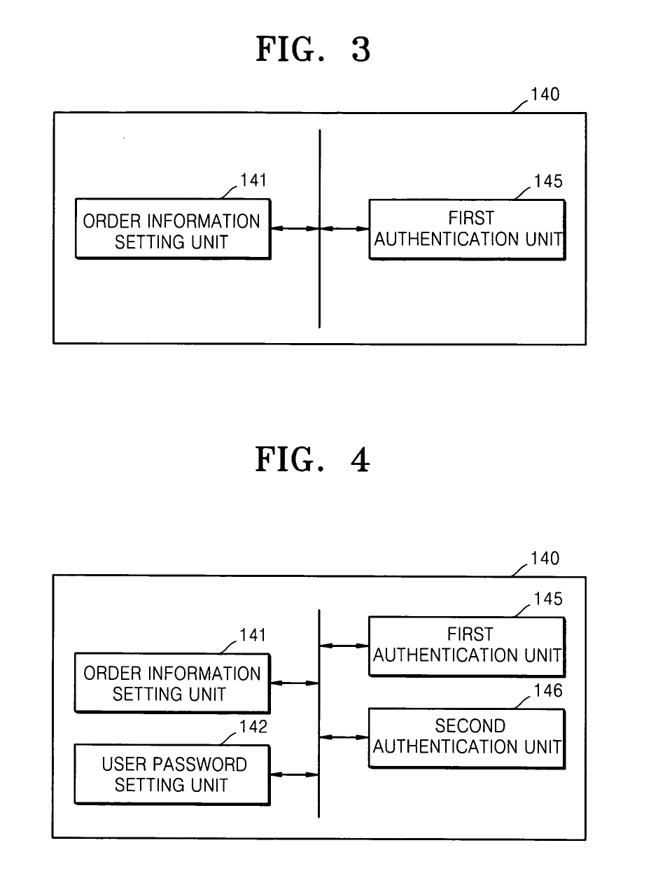

Various embodiments of the control unit 140 will now be described with reference to FIGS. 3 through 5.

FIG. 3 is a block diagram of the control unit 140 illustrated in FIG. 2, according to an embodiment of the present invention. FIG. 3 will be described in conjunction with FIGS. 1-2.

Referring to FIG. 3, the control unit 140 includes an order information setting unit 141 for setting order information corresponding to the selection of a print mode operation. The print mode operation may be selected in order to receive image files input from the interface unit 130, to select some image files from the image files, or to print images of the selected image files. If the print mode operation is selected, the order information corresponding to its selection may be generated by the order information setting unit 141. Here, the order information may include, for example, a date and time of an order and may comprise a combination of numbers and characters. The order information may also be generated when a user selects a pick-up service in order to pick up printed images at a desired time. If, however, the user selects an option to pick up the printed images right after the images are printed, without depositing the printed images, the order information is not generated.

The control unit 140 illustrated in FIG. 3 further includes a first authentication unit 145. The first authentication unit 145 determines whether the order information set by the order information setting unit 141 is identical to the order information that is received by the kiosk 100 in a pick-up mode operation that is performed later when the user picks up the printed images.

The order information in the pick-up mode operation may be input by the user through the input unit 120. Alternatively, the order information in the pick-up mode operation may be input from the external storage device 200 through the interface unit 130. For example, if the print mode operation is selected by inputting image files from the external storage device 200 through the interface unit 130 and selecting desired image files from among the input image files, the order information corresponding to the selection of the print mode operation may be provided to and stored in the external storage device 200. Then, the user may remove or otherwise disconnect the external storage device 200 from the kiosk 100 and may leave the kiosk 100 while the desired images are being printed. When the user returns to the kiosk 100 to pick up the printed images, if the external storage device 200 is reconnected to the interface unit 130, the order information may be input to the kiosk 100 from the external storage device 200. Therefore, the user does not have to memorize the order information or keep a receipt on which the order information is written, and inconvenience to the user may be reduced.

FIG. 4 is a block diagram of the control unit 140 illustrated in FIG. 2, according to another embodiment of the present invention. FIG. 4 will be described in conjunction with FIGS. 1-2.

Referring to FIG. 4, the control unit 140 includes a user password setting unit 142 and a second authentication unit 146 in addition to the order information setting unit 141 and the first authentication unit 145 which are illustrated in FIG. 3. In this embodiment, user passwords are set by a user in order to prevent printed images from being picked up by a third party by mistake or from being stolen. The user passwords may be set in various types of numbers, characters, or combination of numbers and characters. Thus, the user may select a print mode operation, and input a password, which is received by the kiosk, through the input unit 120 so as to correspond to the selection of the print mode operation. The user password setting unit 142 may set the user passwords corresponding to the selection of the print mode operation in accordance with input signals. Accordingly, in a pick-up mode operation to be performed later, the printed images be picked up by the user only if the user passwords, as well as the order information, received by the kiosk during the pick-up operation are identical to user passwords received by and order information set by the kiosk during the print mode operation. Determining whether the user passwords set in the print mode operation are identical to the user passwords input in the pick-up mode operation may be performed by the second authentication unit 146.

When the printed images are picked up, the user passwords, as well as the order information, may be directly input to the kiosk by the user through the input unit 120 or may be input from the external storage device 200. In order to input the user passwords from the external storage device 200, the user inputs and sets the user passwords after the print mode operation is selected and the set user passwords are stored in the external storage device 200 so as to correspond to the selection of the print mode operation.

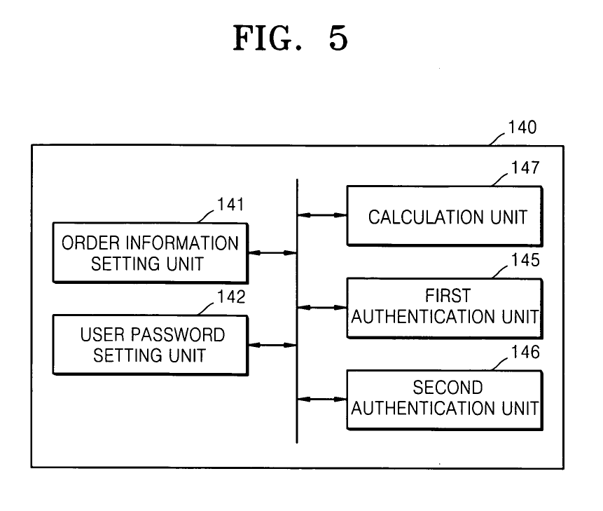

FIG. 5 is a block diagram of the control unit 140 illustrated in FIG. 2, according to another embodiment of the present invention. FIG. 5 will be described in conjunction with FIGS. 1 and 2.

Referring to FIG. 5, the control unit 140 further includes a calculation unit 147 in addition to the order information setting unit 141, the user password setting unit 142, the first authentication unit 145 and the second authentication unit 146 which are illustrated in FIG. 4.

The calculation unit 147 calculates a period of time that it takes to generate printed images 300 in a print mode operation. The period of time may be calculated in consideration of the type of image files, the number of image files, conditions of printing, and the like. The period of time calculated by the calculation unit 147 may be displayed on the display unit 170 to inform the user how long it will be until the printed images 300 are completed. Accordingly, a pick-up time of the printed images 300 may be set based on the calculated period of time. In particular, a user may select a pick-up time to pick up the printed images 300 any time after the calculated period of time has elapsed. The calculated period begins to run at the point in time when the kiosk 100 begins to print images corresponding to the image files. By setting the pick-up time, the user may pick up the printed images 300 at a desired time without waiting around while the images are being printed. The pick-up time may be set by the user or may be automatically set by the kiosk 100.

Returning to FIG. 2, the kiosk 100 further includes a memory 150. The memory 150 may store a program that operates the kiosk 100 and may temporarily store image files input before processing other signals.

In order to pay for printing the images, money is inserted into the kiosk 100. Accordingly, the kiosk 100 may further include a money recognition unit 160. The money recognition unit 160 recognizes a credit card 320 and cash 310, such as coins and bills, and approves payment. If the payment is successful, the print mode operation is performed. If the payment is not successful, the print mode operation is not performed. If the inserted cash 310 exceeds the cost, change is provided to the user. If the user pays with the credit card 320, the money recognition unit 160 connects to a financing server 325 and transmits card information and payment information to the financing server 325. If the payment with the credit card 320 is successfully approved, it is determined that the cost is paid so that the print mode operation can be performed.

The kiosk 100 displays the input image files and an operation state of the kiosk 100 through the display unit 170. Thus, the user may recognize and control operations of the kiosk 100. For example, when the image files are input, the input image files are displayed on the display unit 170 and desired image files to be printed may be selected from among the input image files. Then, a first icon (not shown) for printing the selected image files may be displayed on the display unit 170. If the user selects the first icon, the print mode operation of the selected image files is selected. Also, a second icon (not shown) for pick-up service also may be displayed on the display unit 170. If the user selects the second icon, the pick-up service is applied. By applying the pick-up service, the user may set order information corresponding to the print mode operation and instruct the kiosk 100 to deposit the printed images 300 in accordance with the order information. The user may then leave the kiosk 100 and later return to pick up the deposited images at a desired time, after a predetermined period of time has elapsed, if the order information input by the user and received by the kiosk at the pick-up time is identical to the order information set by the kiosk during the print mode operation. Furthermore, additional icons regarding the operations of the kiosk 100 may be displayed on the display unit 170 so that the user may recognize and select the operations of the kiosk 100.

After the desired image files are selected for printing, the print mode operation of the selected image files is selected, and if the payment is successful, a print unit 180 prints images corresponding to the selected image files and generates printed images 300. The printed images 300 are deposited in the depository 190 in accordance with the order information.

As illustrated in FIG. 1, the depository 190 is composed of a plurality of sub-depositories such as first through fourth sub-depositories 190a, 190b, 190c, and 190d, and the printed images 300 may be deposited in each of the first through fourth sub-depositories 190a, 190b, 190c, and 190c in accordance with the order information set in the print mode operation. For example, if printed images 300 includes a set of first printed images 300a of order #: 200706101855 and a set of second printed images 300b of order #: 200706111110, the first printed images 300a are deposited in the first sub-depository 190a, the second printed images 300b are deposited in the second sub-depository 190b, and no printed images are deposited in the third or fourth sub-depositories 190c and 190d. The printed images 300 are deposited in the depository 190 after the user selects the print mode operation and applies the pick-up service.

Later, when the user returns to the kiosk 100 to pick up the printed images 300, if the user selects the pick-up mode operation and inputs the order information, the control unit 140 receives the order information and determines whether the order information input during the pick-up mode operation is identical to the order information set during the print mode operation. If it is identical, the control unit transmits a corresponding signal to a releasing unit 195 and the releasing unit 195 releases the printed images 300 corresponding to the identical order information.

In more detail, the first authentication unit 145 determines whether the order information set in the print mode operation is identical to the order information input in the pick-up mode operation. If the order information is identical, the releasing unit 195 receives a control signal from the first authentication unit 145 and releases the printed images 300 deposited in the depository 190 in accordance with the control signal. In this case, the printed images 300 that correspond to the order information are deposited in the depository 190.

For example, if the user selects the pick-up mode operation and inputs order information 200706101855, the releasing unit 195 releases the first printed images 300a corresponding to the order information 200706101855. In this case, the releasing unit 195 may adjust the first through fourth sub-depositories 190a, 190b, 190c, and 190d upwards and downwards in accordance with the control signal of the control unit 140 so that the position of the first sub-depository 190a corresponds to the position of the releaser 198. Then, the releasing unit 195 may release the first printed images 300a deposited in the first sub-depository 190a to the outside.

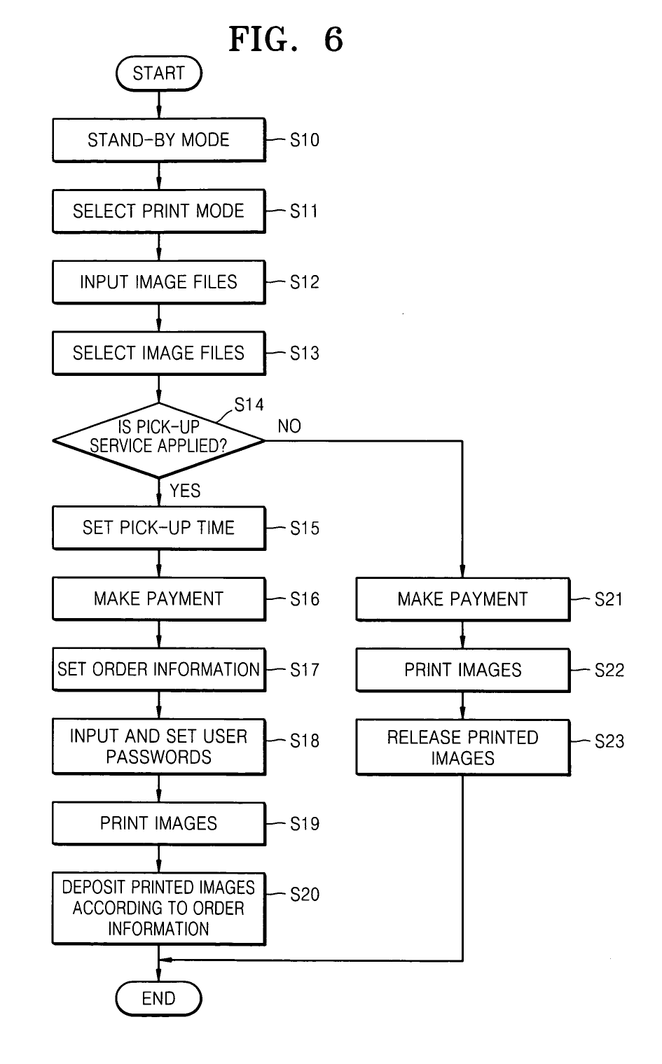

Hereinafter, a method of controlling a kiosk for printing images according to the present invention will be described in detail by explaining embodiments of the invention with reference to FIGS. 6 through 8.

FIG. 6 is a flowchart illustrating a print mode operation of a kiosk, according to an embodiment of the present invention. In the current embodiment, it is assumed that user passwords as well as order information are set so as to correspond to selection of the print mode operation.

Referring to FIG. 6, in operation S10 the kiosk is in a stand-by mode. In operation S11, a user selects the print mode operation and the print mode operation is performed.

In operation S12, one or more image files are input in the print mode operation. The image files may be input from an external storage device connected to the kiosk. In operation S13, desired image files to be printed are selected from among the input image files.

In operation S14, the kiosk determines whether the user chose to apply a pick-up service. By applying the pick-up service, the user may set order information corresponding to the print mode operation, deposit printed images in accordance with the order information, and pick up the deposited images at a desired time after a predetermined period of time if the order information input by the user at the time of pick-up is identical to the order information generated at when the user applies the pick-up service in the pick-up mode operation.

If the user applies the pick-up service, in operation S15 a pick-up time is set. The pick-up time is a point of time when the user wants to pick up the printed images or a waiting time to be taken until the print mode operation is completed. The pick-up time may be set by the user or may be automatically set by the kiosk. The pick-up time may be set based on a period of time that it takes to print images corresponding to the selected image files. The period of time may be calculated in consideration of the number and size of the image files, and the like, by the kiosk. By setting the pick-up time based on the period of time for printing, the user may leave the kiosk and then return to pick up the printed images at a desired time instead of waiting around while the images are being printed.

In operation S16, the user pays for the cost of printing the images. In a kiosk according to an embodiment of the present invention, payment may be made with coins and bills. Also, payment may be made with a credit card or a gift card by connecting to a financial server.

In operation S17, an order number is set for selection of the print mode operation and for applying a pick-up service. If necessary, the user or kiosk may set a user password in operation S18. Then, in operation S19, the kiosk prints images corresponding to the selected image files. In operation S20, the printed images are deposited in accordance with the order number set in operation S17. A deposit time of the printed image may correspond to the pick-up time set in operation S15.

Returning to step S14, if the user does not apply the pick-up service, in operation S21 the user pays for the cost of printing the images and, in operation S22, the images are printed. Then, in operation S23, the printed images are directly released instead of being deposited.

The order information and/or the user passwords may be displayed or be output on a receipt so as to inform the user. Alternatively, the order information and/or the user passwords may be stored in the external storage device providing the image files and then be provided from the external storage device in a pick-up mode operation to be performed later.

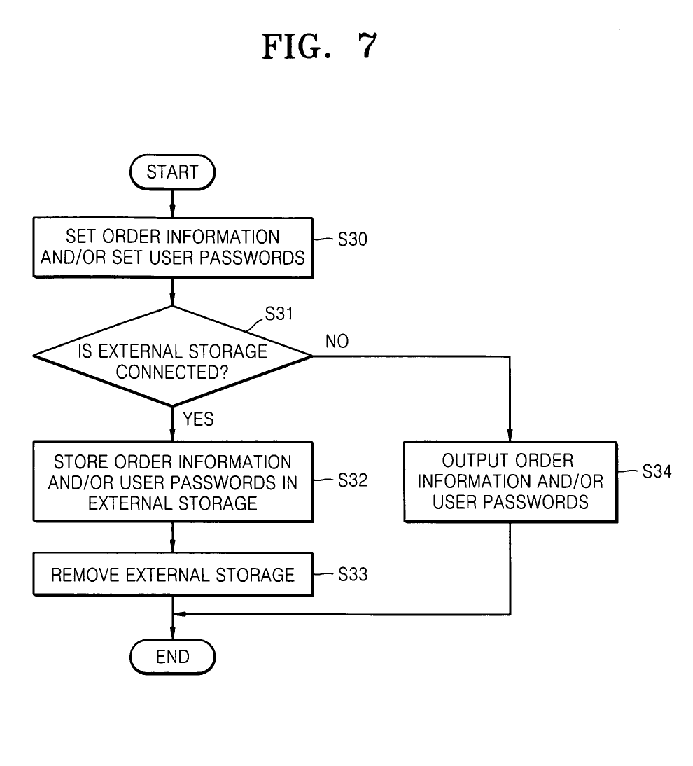

A method of processing the order information and the user passwords will now be described in detail with reference to FIG. 7.

FIG. 7 is a flowchart illustrating a method of processing order information and user passwords of a kiosk, according to an embodiment of the present invention.

Referring to FIG. 7, in operation S30 the order information and the user passwords are set in the print mode operation. In operation S31, the kiosk determines whether an external storage device is connected to the kiosk.

If the external storage device is connected to the kiosk, in operation S32 the order information and/or the user passwords are stored in the external storage device. In operation S33, the external storage device is disconnected from the kiosk. Then, a user may take the external storage device and leave the kiosk while the images are being printed.

If the external storage device is not connected to the kiosk, in operation S34, the order information and/or the user passwords are displayed on a display screen or are output on a receipt. Then, the user may memorize the order information and/or the user passwords displayed on the display screen or may take the receipt with him/her when he/she leaves the kiosk. The user may have free time while the images are being printed.

If the user has applied a pick-up service in a print mode operation performed in advance, the printed images are deposited to be picked up later at a pick-up time instead of immediately releasing the printed images. The user may pick up the printed images after the pick-up time in a pick-up mode operation.

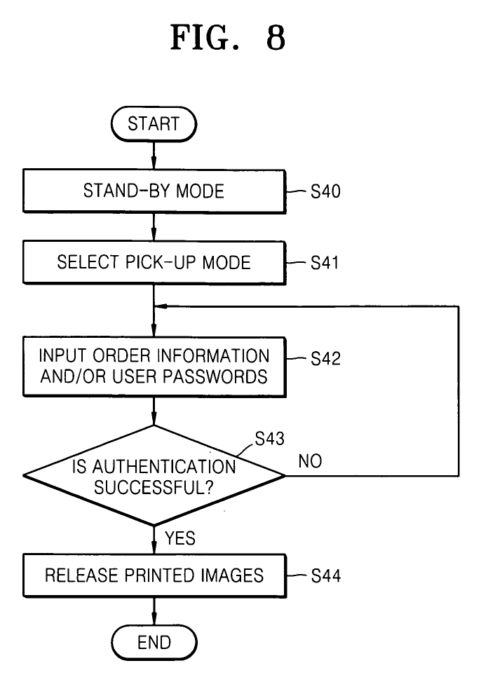

The pick-up mode operation will now be described in detail with reference to FIG. 8. FIG. 8 illustrates a pick-up mode operation of a kiosk, according to an embodiment of the present invention.

Referring to FIG. 8, in operation S40, the kiosk is in a stand-by mode. In operation S41, a user selects the pick-up mode operation and the pick-up mode operation is performed in operations S42-S44.

In operation S42, the user inputs order information and user passwords in the pick-up mode operation.

In operation S43, the kiosk determines whether the order information and the user passwords input in the pick-up mode operation are respectively identical to the order information and the user passwords which were set in a print mode operation. If they are identical, that is, if authentication is successful, in operation S44 printed images that were deposited in the print mode operation are released. If they are not identical, that is, if the authentication is not successful, the user may re-input the order information and/or the user passwords. The determination is performed separately on the order information and the user passwords. If the order information is not identical, the order information may be re-input and if the user passwords are not identical, the user passwords may be re-input.

Accordingly, if the authentication is successful, the user may pick up the printed images released in operation S44.

The order information and the user passwords may be directly input by the user or may be input from an external storage device.

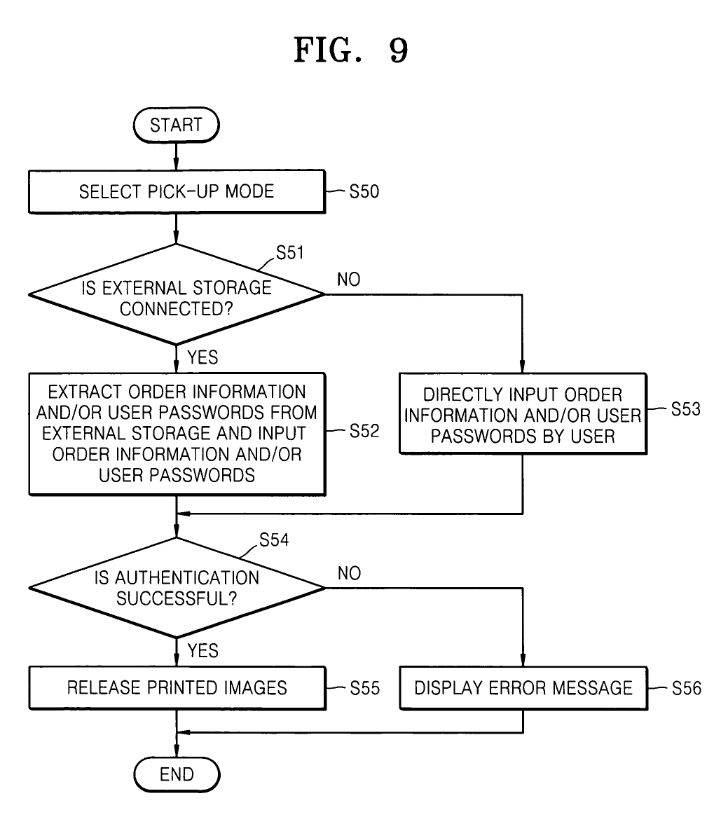

A method of inputting the order information and the user passwords in the pick-up mode operation will now be described in detail with reference to FIG. 9.

FIG. 9 is a flowchart illustrating a method of inputting order information and/or user passwords in a pick-up mode operation of a kiosk, according to an embodiment of the present invention.

Referring to FIG. 9, in operation S50 the kiosk is in the pick-up mode operation. In operation S51, the kiosk determines whether an external storage device is connected to the kiosk. If the external storage device is connected to the kiosk, in operation S52 the order information and/or the user passwords may be extracted and input from the external storage device. If the external storage device is not connected to the kiosk, in operation S53, the order information and/or the user passwords may be directly input by a user.

Then, in operation S54, the kiosk determines whether the order information and/or the user passwords input during the pick-up mode either from the external storage device in operation S52 or directly by the user in operation S53 are respectively identical to the order information and/or the user passwords which were set in a print mode operation. Otherwise, it is determined whether any one of a plurality of pieces of order information and/or a plurality of user passwords which are set in the print mode operation is identical to any one piece of the order information and/or the user passwords which are input from the external storage device or are input by the user. If they are identical, in operation S55, printed images deposited in the print mode operation are released in accordance with the order information. If they are not identical, in operation S56 an error message is displayed.

As described above, according to an embodiment of the present invention, by performing a print mode operation in which images corresponding to one or more image files input from an external storage device are printed and deposited and by performing a pick-up mode operation which enables a user to pick up the printed images under predetermined conditions, the user does not have to wait around while the images are being printed. Since the user may have free time while the images are being printed, the user is not required to unnecessarily waste time and can utilize his or her time efficiently.

Also, according to an embodiment of the present invention, user passwords as well as order information may be separately set. By setting the user passwords, printed images generated in a print mode operation are prevented from being stolen or from being taken by a third party by mistake. Deposited images may be released by identifying the user passwords set by the user. In a pick-up mode operation, the order information and/or the user passwords may be directly input by the user or be input from an external storage device. In more detail, the order information and/or the user passwords which are set in the print mode operation are stored in the external storage device and are provided from the external storage device to a kiosk when in the pick-up mode operation later, instead of the user inputting the order information and/or the user passwords. Thus, the inconvenience to the user of inputting the order information and/or the user passwords may be reduced.

Furthermore, according to an embodiment of the present invention, a period of time that it takes to print images may be calculated and a user may be informed about the calculated period of time, i.e., the user may be informed how long it will take for the images to be printed. The user may set a pick-up time for picking up the printed images based on the calculated period of time. Thus, the user has free time while the images are being printed. The user may leave the kiosk and return to pick up the printed images at a desired time without waiting around.

While the present invention has been particularly shown and described with reference to exemplary embodiments thereof, it will be understood by those of ordinary skill in the art that various changes in form and details may be made therein without departing from the spirit and scope of the invention as defined by the appended claims. The exemplary embodiments should be considered in a descriptive sense only and not for purposes of limitation. Therefore, the scope of the invention is defined not by the detailed description of the invention but by the appended claims, and all differences within the scope will be construed as being included in the present invention.

What is claimed is:

1. A method of controlling an unmanned automatic terminal for printing images, the method comprising:
performing a print mode operation, wherein the print mode operation comprises generating at least one printed image by printing at least one image corresponding to at least one image file and depositing the at least one printed image in a depository; and
performing a pick-up mode operation, wherein the pick-up mode operation comprises releasing the at least one printed image from the depository under at least one predetermined condition.

2. The method of claim 1, wherein:
the print mode operation further comprises setting order information;
the pick-up mode operation further comprises receiving order information; and
the at least one predetermined condition is satisfied when the order information set in the print mode operation is identical to the order information received in the pick-up mode operation.

3. The method of claim 1, wherein:
the print mode operation further comprises receiving a password set by a user; and
the pick-up mode operation further comprises receiving a password input by a user; and
the at least one predetermined condition is satisfied when the password received in the pick-up mode operation is identical to the password received in the print mode operation.

4. The method of claim 2, wherein the at least one image file is received from an external storage device connected to the terminal.

5. The method of claim 2, wherein in the print mode operation, the location in the depository at which the at least one printed image is deposited is based upon the order information.

6. The method of claim 4, wherein the print mode operation further comprises storing the order information on the external storage device.

7. The method of claim 6, wherein in the pick-up mode operation the terminal receives the order information from the external storage device.

8. A method of controlling an unmanned automatic terminal for printing images, the method comprising:
detecting selection of a print mode operation;
if the print mode operation is selected, setting order information, receiving at least one image file, printing at least one image that corresponds to the at least one image file, and depositing the printed at least one image in a depository;
detecting selection of a pick-up mode operation; and
if the pick-up mode operation is selected, receiving order information input by a user, determining whether the order information received in the pick-up mode operation is identical to the order information set in the print mode operation, and releasing the at least one printed image from the depository if the order information received in the pick-up mode operation is identical to the order information set in the print mode operation.

9. The method of claim 8, further comprising:
if the print mode operation is selected, receiving and setting a password; and
if the pick-up mode operation is selected, receiving a password input by the user, determining whether the password received from the user in the pick-up mode operation is identical to the password set in the print mode operation, and releasing the at least one printed image if password received in the pick-up mode operation is identical to the password set in the print mode operation.

10. The method of claim 8, wherein:
the print mode operation further comprises storing the order information set in the print mode operation in an external storage device; and
in the pick-up mode, the order information input by the user is received by the unmanned automatic terminal from the external storage device.

11. The method of claim 8, wherein the print mode operation further comprises setting a pick-up time for the at least one printed image.

12. The method of claim 8, wherein the print mode operation further comprises calculating a period of time for printing the at least one image.

13. An unmanned automatic terminal for printing images, the unmanned automatic terminal comprising:
an input unit for selecting a print mode operation or a pick-up mode operation;
an interface unit for receiving at least one image file from an external storage device;
a print unit for printing at least one image corresponding to the at least one image file so as to generate at least one printed image in a print mode operation;
a depository in which the at least one printed image is deposited in the print mode operation and from which the at least one printed image may be released during a pick-up mode operation;
a control unit comprising an order information setting unit for setting order information in the print mode operation and a first authentication unit for determining whether order information received in the pick-up mode is identical to the order information set in the print mode operation; and
a releasing unit for releasing the at least one printed image if the order information received in the pick-up mode is identical to the order information set in the print mode operation.

14. The unmanned automatic terminal of claim 13, wherein the control unit further comprises a user password setting unit for setting passwords in the print mode operation and a second authentication unit for determining whether a password received in the pick-up mode operation is identical to a password set in the print mode operation.

15. The unmanned automatic terminal of claim 14, wherein the input unit receives the order information and the passwords.

16. The unmanned automatic terminal of claim 13, wherein in the print mode operation the order information is stored in the external storage device and in the pick-up mode operation the order information is received by the terminal from the external storage device.

17. The unmanned automatic terminal of claim 13, wherein the control unit further comprises a calculation unit for calculating a period of time for printing the at least one image.

18. The unmanned automatic terminal of claim 13, wherein the depository comprises a plurality of sub-depositories.

19. The unmanned automatic terminal of claim 18, wherein the at least one printed image is stored in one of the plurality of sub-depositories in accordance with the order information.

20. The unmanned automatic terminal of claim 13, wherein the releasing unit releases the at least one printed image deposited in the depository in accordance with a control signal of the first authentication unit of the control unit.
